(19) United States
(12) Patent Application Publication
(10) Pub. No.: US 2008/0065475 A1
(43) Pub. Date: Mar. 13, 2008

(54) Synchronized digital topper

(76) Inventor: Minh Phan, Costa Mesa, CA (US)

Correspondence Address: WALTER A. HACKLER, 2372 S.E. BRISTOL, SUITE B, NEWPORT BEACH, CA, 92660-0755, US

(21) Appl. No.: 11/507,902

(22) Filed: Aug. 22, 2006

(51) Int. Cl. G07G 1/14

(52) U.S. Cl. 705/14; 705/16

(57) ABSTRACT

A gas pump video display system for a gas station generally includes a plurality of spaced apart audio/visual display units with each unit being driven by an audio/video amplifier receiver. An audio/video distribution box with a CPU is provided and interconnected with each of the audio/video display units for a delivery of synchronized signals to reduce an effective extraneous noise on the customer within the listening and viewing area.

The present invention is generally related to an information transmission and display system and is more particularly directed to a gas pump video display system for presenting advertisement and general news information.

In most, if not all, gasoline service stations exposure to information such as advertising, information, and current news information is omnipresent.

Service station display systems should have the ability to target specific audiences with information, respond quickly and easily to information changes and provide a consistent high quality and information content, particularly for the effective communication of advertisement.

Heretofore, utilized display systems for service stations have included static devices such as signs and billboards and placards disposed throughout the station as well as adjacent the gasoline pumps, often top of the pumps and such systems are often called “toppers”.

Limitations of this type of advertisement include the fact that messages or information is not easily updateable and the information is restricted to basic text and primitive graphic data. Importantly, such as system does not provide for an easily updateable real time information delivery and display system.

More advanced display systems have included television monitors and audio systems for presenting news and advertisement. These systems are independently operated and typically multiple installation of such displays are not synchronized within the listening and viewing area and accordingly generate a cacophony which may be irritating to customers.

The present invention provides for a display system for a gas station utilizing synchronized audio/video display units driven by a single CPU which substantially reduces the cost of the system.

### SUMMARY OF THE INVENTION

A gas pump video display system for a gas station in accordance with the present invention generally includes a plurality of spaced apart audio/visual display units each driven by an audio/video amplifier receiver. No separate communication or CPU is necessary for each of these units. This significantly reduces the cost of the system.

An audio/video distribution box with a CPU is interconnected with each of the plurality of audio/video display units for a delivery of synchronized signals to each of the audio/visual amplifier receivers in order to produce synchronized audio/video to a customer within a listening and viewing area produced by the plurality of audio/visual display units thereby reducing extraneous noise on the customer within the listening and viewing area.

A wireless Ethernet transceiver is provided to input the CPU with the input including input selected from a group comprising media broadcast and separately generated advertisements. In this manner, information, including advertisements, may be displayed and controlled in a synchronous manner at the gas station.

More particularly, each of the display units may include a computer which is controlled by the CPU for playing a content on an associated display unit. The content may comprise a variety of static graphics, text, audio and video content in a continuous loop with the content being stored in the computer.

In addition, the interconnection between the distribution box and the display units may be wireless.

In one embodiment of the present invention display units each include opposing display panels with the units being sized for installation over an associated gas pump.

Alternatively, the display units may include single display panels and mounted for display at positions within the gas station to establish the listening and viewing areas.

Conjunctively, a method for providing gas pump video displays for gas stations includes providing a plurality of spaced apart audio/video display units each driven by an audio/video amplifier receiver along with an audio/video distribution box with a CPU.

Interconnection is provided with each of the plurality of audio/video display units for delivery of synchronized signals to each of the audio/video amplifier receivers in order to produce synchronized audio/video to a customer within a listening and viewing area produced by the plurality of audio/video display units thereby reducing an effect of extraneous noise (cacophony) on the customer within the listening and viewing area. In addition, a wireless Ethernet transceiver may be provided for providing input to the CPU with the input including input select from a group comprising media broadcast and separately generated advertisements.

In order to further coordinate operation of the audio/video displays, motion sensor may be provided to control the audio/video displays. That is, the audio/video displays are operative only when a customer is present in a designated field.

### BRIEF DESCRIPTION OF THE DRAWINGS

The present invention may be more clearly understood with references to the following detailed description, in connection with the appended drawings, in which:

FIG. 1 is an illustration of the system in accordance with the present invention as it may be installed in a gas station for establishing a listening and viewing area proximate gas pumps; and

FIG. 2 is a block diagram of the gas pump video display system in accordance with the present invention.

### DETAILED DESCRIPTION

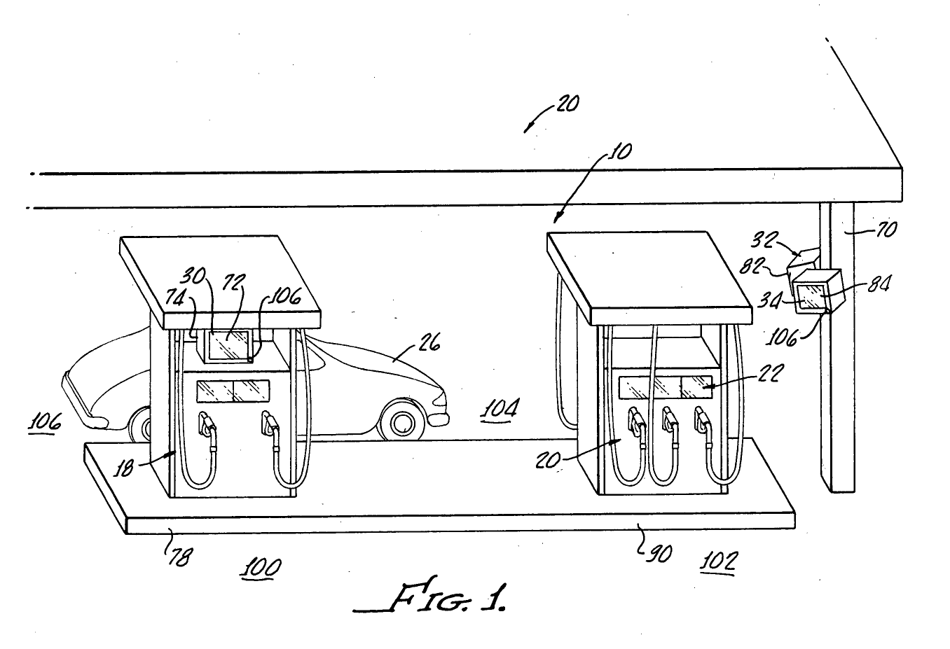

With reference to FIG. 1, there is shown a gas pump video display system 10 for a gas station 12 having a plurality of spaced apart conventional pumps 18, 20, 22 for servicing an auto 26 or truck (not shown) with multiple vehicles being serviceable in a conventional manner.

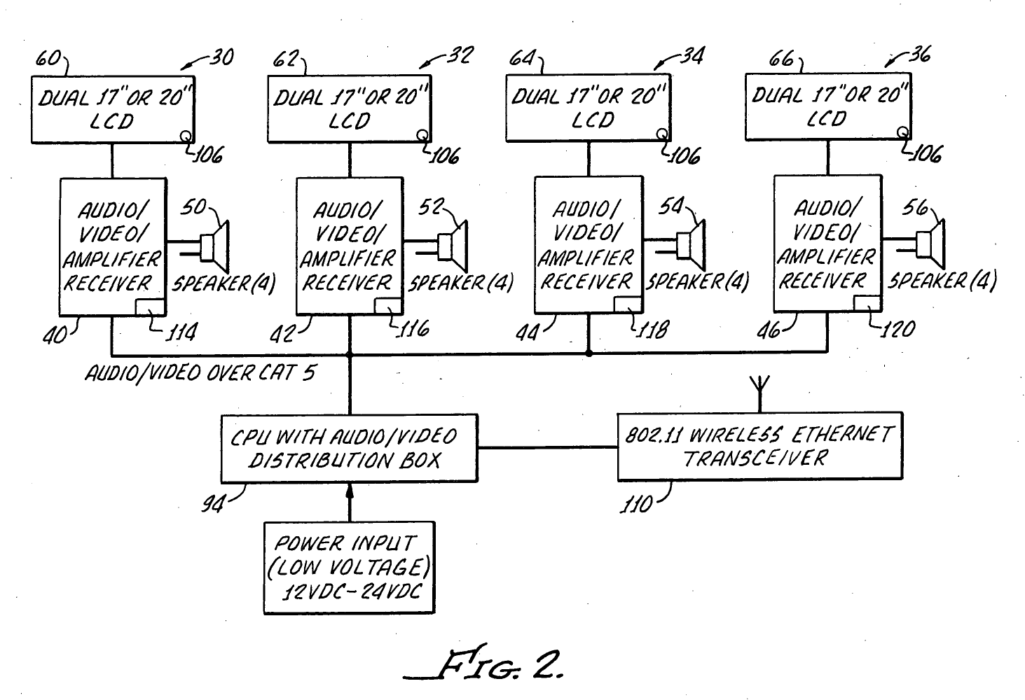

With reference also to FIG. 2, the system includes a plurality of spaced apart audio/visual display units 30, 32, 34, 36 with each being driven by an audio/video amplifier receiver 40, 42, 44, 46 for producing audio through speakers and video through sunlight readable 17 or 20 inch LCD panels 60, 62, 64, 66.

Units 32, 34 may be poll 70 mounted or, as illustrated in FIG. 1, another receiver 30 may be utilized as a “topper” on the gas pump 18. A display unit 30 may include opposing screens in order that customers each side of the pump island 78 can view one of the screens 72, 74.

Alternatively, the units 32, 34 may include single screens 82, 84 respectively for any customers (not shown) on both sides of an island supporting the pumps 20, 22 to view the display.

As illustrated in FIG. 2, an audio/visual distribution box 94 is interconnected with each of the plurality of audio/visual display units 30, 32, 34, 36 for delivery of synchronized signals to each of the audio/visual amplifier receivers 40, 42, 44, 46 in order to produce synchronized audio/visual to a customer within listening and viewing areas 100, 102, 104, 106 produced by the plurality of audio/visual display units 30, 32, 34, 36 thereby inducing an effective extraneous noise on the customer within the listening and viewing areas 100, 102, 104, 106.

This synchronization is enabled through the distribution box 94 utilizing appropriate circuitry. A typical installation consists of 4 to 6 units 30, 32, 34, 36 depending upon the number of islands 78, 102.

A wireless Ethernet transceiver 110 may be utilized for providing an input to the distribution box with the input including input selected from a group providing media broadcast and separately generated advertisements.

As illustrated in FIG. 2, each of the units 30, 32, 34, 36 may include a computer 114, 116, 118, 120 controlled by the CPU and the distribution box 94 for playing content on an associated display unit 30, 32, 34, 36 with the content comprising a variety of static graphics, text, audio or visual content in a continuous loop, with the content being stored in the computer 114, 116, 118, 120.

While the communication between the distribution box 94 and units 30, 32, 34, 36 is illustrated by wires 124, it should be appreciated that such communication may be achieved through wireless transmitters and receivers in a conventional manner.

With reference to FIG. 1 and as hereinabove noted, the unit 30 may include opposing display panels 72, 74 and sized installation over an associated pump 18 thus replacing a static topper (not shown) with the digital topper 30 in order to display video and audio contents for advertisements, as hereinabove described.

As shown, the units 32, 34 each include a signal display panel 82, 84 which act in concert to produce a synchronized audio/visual presentation to a customer within the listening and viewing area 102.

The system 10 may also include motion sensors 106, which may be of any suitable type, and disposed on the display units 30, 32, 34, 36 for detecting the presence of a customer in the viewing area 100, 102, 104, 106 and operative for turning on and off the audio/video of a corresponding display unit 30, 32, 34, 36.

A method in accordance with the present invention and providing gas pump video displays for a gas station 12 generally includes providing a plurality of spaced apart audio/visual display units 30, 32, 34, 36 each driven by an audio/visual amplifier/receiver 40, 42, 44, 46 and providing an audio/distribution box 94 with a CPU which is interconnected with each of the audio/visual display units 30, 32, 34, 36 for a delivery of synchronized signals to each of the audio/visual amplifier receivers 40, 42, 44, 46 in order to produce synchronized audio/video to a customer within a listening and viewing area 100, 102 thereby reducing an effective extraneous noise from the customer within the listening and viewing area 100, 102.

Although there has been hereinabove described a specific synchronized digital topper in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

1. A gas pump video display system for a gas station, the system comprising:
a plurality of spaced apart audio/video display units each driven by an audio/video amplifier receiver;
an audio/video distribution box with a CPU interconnected with each of the plurality of audio/video display units for delivery of synchronized signals to each of the audio/video amplifier receivers in order to produce synchronized audio/video to a customer within a listening and viewing area produced by the plurality of audio/video display units thereby reducing an effect of extraneous noise on the customer within the listening and viewing area; and
a wireless Ethernet transceiver for providing input to said CPU, said input including input selected from a group comprising media broadcasts and separately generated advertisements.

2. The system according to claim 1 wherein each display unit includes a computer, controlled by the CPU, for playing a content on an associated display unit, said content comprising a variety of static graphics, text, audio and video content in a continuous loop, said content being stored in the computer.

3. The system according to claim 1 wherein the interconnection between the distribution box and the display units is wireless.

4. The system according to claim 1 wherein the display units each include opposing display panels.

5. The system according to claim 4 wherein the display units are sized for installation over an associated gas pump.

6. The system according to claim 1 wherein the display units each include a single display panel.

7. The system according to claim 6 further comprising supports for mounting each display panel at positions within the gas station to establish the listening and viewing areas.

8. The system according to claim 2 wherein the interconnection between the distribution box and the display units is wireless.

9. The system according to claim 2 wherein the display units each include opposing display panels.

10. The system according to claim 9 wherein the display units are sized for installation over the gas pump.

11. The system according to claim 2 wherein the display units each include a single display panel.

12. The system according to claim 11 further comprising supports for mounting each display panel at positions within the gas station to establish the listening and viewing areas.

13. The system according to claim 1 further comprising a motion sensor disposed at a position and controlling operation of at least one of the audio/video display units only when a customer is present in the listening and viewing area.

14. A method for providing gas pump video display for a gas station, the method comprising:
providing a plurality of spaced apart audio/video display units each driven by an audio/video amplifier receiver;
providing an audio/video distribution box with a CPU;
providing an interconnected with each of the plurality of audio/video display units for delivery of synchronized signals to each of the audio/video amplifier receivers in order to produce synchronized audio/video to a customer within a listening and viewing area produced by the plurality of audio/video display units thereby reducing an effect of extraneous noise on the customer within the listening and viewing area; and
providing a wireless Ethernet transceiver for providing input to said CPU, said input including input selected from a group comprising media broadcasts and separately generated advertisements.

15. The method according to claim 14 wherein providing a plurality of display units includes providing each display unit with a computer, and controlling the computers by the CPU, for playing a content on an associated display unit, said content comprising a variety of static graphics, text, audio and video content in a continuous loop, said content being stored in the computer.

16. The method according to claim 14 wherein providing the interconnection between the distribution box and the display units include providing a wireless interconnection.

17. The method according to claim 14 wherein providing the display units includes providing display units each having opposing display panels.

18. The method according to claim 14 wherein providing the display units includes providing display units sized for installation over an associated gas pump.

19. The method according to claim 14 wherein providing the display units includes providing display units each having a single display panel.

20. The method according to claim 19 further comprising providing supports for mounting each display panel at positions within the gas station to establish the listening and viewing areas.
